(19) United States
(12) Patent Application Publication
(10) Pub. No.: US 2023/0272770 A1
(43) Pub. Date: Aug. 31, 2023

(54) VARIABLE-HEAD HYDROELECTRIC POWER PLANT

(71) Applicant: Ezio VENTURINI DELSOLARO, Crevoladossola (VB) (IT)

(72) Inventor: Ezio VENTURINI DELSOLARO, Crevoladossola (VB) (IT)

(21) Appl. No.: 18/005,644

(22) PCT Filed: Jul. 13, 2021
(86) PCT No.: PCT/IB2021/056281

§ 371 Date: Jan. 16, 2023

(30) Foreign Application Priority Data
Jul. 17, 2020 (IT) 102020000017482

(51) Int. Cl. F03B 13/08

(52) U.S. Cl. CPC F03B 13/08; F05B 2240/93

(57) ABSTRACT

A variable-head hydroelectric power plant having an upstream intake works adapted to intercept at least partially the water coming from a source, a pipeline connected to the upstream intake works to receive and channel therein, at least partially, the water intercepted by the upstream intake works is disclosed. The power plant further includes a floating platform, adapted to be arranged and to float on the surface of a basin, and a hydraulic turbine arranged on the floating platform and connected to the pipeline to receive the water coming from the pipeline.

### FIELD OF THE INVENTION

The present invention relates to a hydroelectric power plant according to the preamble of the main claim.

Hydroelectric power plants that use considerable elevation heads comprise a basin, generally a natural or artificial lake, from which water is fed into penstocks to reach the valley where it rotates the impeller of a hydraulic turbine.

The impeller of the hydraulic turbine is connected to an electromechanical device for converting mechanic energy into electric energy, generally an alternator or a dynamo, and said electric energy is then fed into the grid.

Depending on seasons, the water inflows and outflows and evaporation, the basin may contain a greater or lesser amount of water, so that the free surface of the water in the basin may be at a higher or lower elevation.

The basin receives water from several rivers or streams flowing downstream and can also receive water from rivers or streams of nearby valleys, thanks to channelisation works that include tunnels connecting one valley to the other.

In order to convey the water to said basin also from nearby valleys and to limit the losses, upstream intake works, generally made of cement, which collect the water and cause it to flow out to the same basin, are normally arranged upstream of the basin.

An upstream intake works is a manufactured product adapted to collect the water. The upstream intake works is equipped with suitable regulation systems (e.g., for the modulation of the water outflow, the release of a possible minimum vital outflow, the general securing of the area and plant, the depressurisation of pipelines and manufactured products made on the downstream plant works of the same intake works), of filtration of the water intercepted (screeners, desilting basins or other) and possibly of video surveillance/monitoring.

The elevation head between the upstream intake and the free surface of the water in the basin is therefore variable according to whether the reservoir is more or less full.

Artificial water basins are also made, e.g., for irrigation, for creating a water tank for artificial snow-making or for other purposes other than the production of hydroelectric energy.

A basin may more commonly comprise a natural or artificial lake, but also a forebay, a lagoon or a stretch of sea where the water level can vary by more or less significant values both for human factors (level regulation) and for weather factors (rains, snow/ice melting, drought periods, evaporation and any other event related to weather conditions) or natural factors, such as for example weather conditions, wind, lunar cycles and tides.

### KNOWN PRIOR ART

In the state of the art, the elevation head between the upstream intake works and the free surface of the water in the basin is not exploited to produce electric energy, in particular, the elevation head between the level of maximum storage capacity of the basin and the free surface of the water at intermediate levels of the basin, is not exploited, since, given the great variability of the water level in the basin, a turbine room arranged below the level of maximum storage capacity could be flooded and not only would the turbine fail to produce energy but considerable damage would be caused to the electric devices and, in particular, to the device for converting mechanic energy into electric energy.

This constitutes a considerable and easily quantifiable annual energy waste, considering the elevation of the upstream intake works and the average annual water level in the basin.

### AIMS OF THE INVENTION

Object of the present invention is therefore to implement a hydroelectric power plant which allows to use the elevation head between the upstream intake works and the free surface of the basin, regardless of whether this free surface has a highly variable elevation.

Another object is to implement a hydroelectric power plant that can produce electric energy in a safe and inexpensive manner.

Said objects are achieved by a hydroelectric power plant whose inventive characteristics are highlighted by the claims.

### BRIEF DESCRIPTION OF THE FIGURES

The invention will be better understood from the following detailed description provided purely by way of non-limiting example, of a preferred embodiment depicted in the accompanying drawings, in which:

FIGS. 1A and 1B show the hydroelectric power plant in the event the water level in the basin is high and low, respectively;

FIG. 2 shows the production island comprising the floating platform;

FIG. 3 shows the upstream intake works.

### DETAILED DESCRIPTION OF THE FIGURES AND METHODS OF CARRYING OUT THE INVENTION

With reference to the figures, it can be seen that the hydroelectric power plant according to the invention comprises:
an upstream intake works 1 adapted to intercept at least partially the water coming from a source;
a pipeline 2, connected to said upstream intake works 1, in a manner adapted to receive and conduct downstream the water intercepted by the upstream intake works 1;
a floating platform 3, adapted to be arranged and to float on the surface of a basin 10, such as for example a natural or artificial lake, said basin 10 being at a level lower than the elevation where the upstream intake works 1 is located;
a hydraulic turbine 4 arranged on the floating platform 3 and connected to the pipeline 2, in a manner adapted to receive the water coming from the pipeline 2.

The hydraulic turbine 4 can be a Pelton turbine, as in the figures, but also a Francis turbine, a Kaplan turbine or any hydraulic turbine.

The pipeline 2 has an inlet mouth connected to the upstream intake works 1 and an outlet mouth connected to the hydraulic turbine 4.

The water exits the upstream intake works 1, flows in the pipeline 2 and is conveyed on the impeller of the hydraulic turbine 4, causing it to rotate.

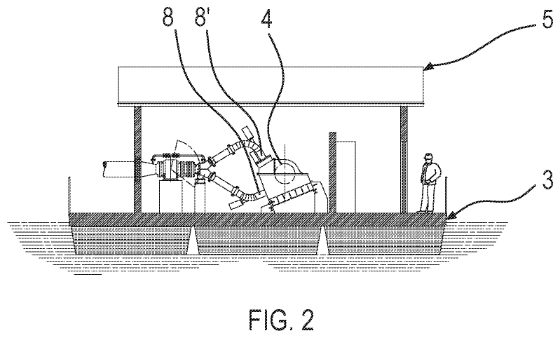

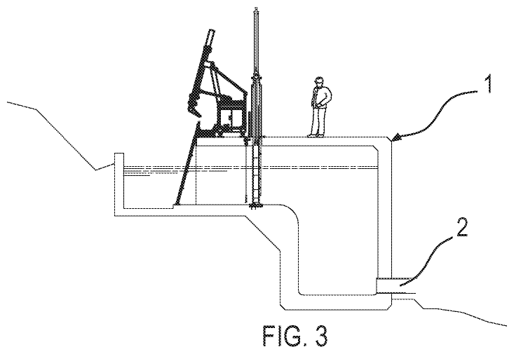

In FIG. 2, it can be seen that the water coming from the pipeline 2 is conveyed on the impeller of the hydraulic turbine 4 by two outflow nozzles 8 and 8′.

The floating platform 3 with all there is above it constitutes the production island 5.

This production island 5 comprises the floating platform 3, the hydraulic turbine 4, an electromechanical device for converting mechanic energy into electric energy and possibly other devices and elements.

The pipeline 2 comprises a rigid upstream reach 2A constrained to the upstream intake works 1 and a flexible or movable downstream reach 2B constrained on one side to the upstream reach 2A and on the other side to the hydraulic turbine 4, which is located on the floating platform 3.

The term flexible or movable downstream reach 2B means a reach of the pipeline 2 which has an outlet mouth adapted to move at least vertically, such downstream reach 2B can therefore be flexible, deformable, extensible, shortenable, e.g., telescopically, or movable in such a way that the outlet mouth can move and be positioned at different elevations.

This downstream reach 2B of the pipeline 2 can therefore comprise a flexible or deformable tubular element which can also be made of one or more rigid elements connected to each other and to the upstream reach by flexible elements or joints.

The upstream reach 2A of the pipeline 2 is constrained to the ground, while the downstream reach 2B of the pipeline 2 partially rests on the ground, in particular when the water level of the basin is low.

Floats 9 are arranged on the downstream reach 2B of the pipeline 2, allowing the floating of the downstream reach 2B.

Alternatively, the downstream reach 2B of the pipeline 2 can be made of floating material.

In order to avoid curves which could cause tensions to the downstream reach 2B of the pipeline 2, under said downstream reach 2B, sufficiently high floats can be arranged to raise the downstream reach 2B of the pipeline 2 at the level of the inlet mouth of the turbine 4.

The hydroelectric power plant also comprises a positioning device adapted to keep the position of the floating platform 3 fixed on the surface of the basin 10 or to limit its displacement.

Said positioning device can comprise a set of motors, propellers and GPS (Global Positioning System) adapted to correct the variations in the position of the floating platform 3 while keeping them within pre-set limits.

More simply, said positioning device may comprise an anchoring device with fixed points by means of flexible elements 6, such as ropes, cables or chains.

The fixed points can be achieved by anchor logs immersed in the basin.

Advantageously, the hydroelectric power plant comprises a device for tensioning said flexible elements 6: when the level of the basin lowers, the flexible elements 6 are partially rolled in so as to remain stretched, whereas, when the basin level rises, said flexible elements 6 are released but still kept stretched, in order to keep the floating platform 3 always in the desired position or at least to limit its displacements on the surface of the basin.

In the most common case, the hydroelectric power plant comprises an electromechanical device for converting mechanic energy into electric energy, such as for example an alternator, for the production of alternating current, or a dynamo, for the production of direct current. The production of direct current with a dynamo has the advantage that it is possible to produce current even with minimum water flow rates.

It is also possible that the hydroelectric power plant comprises a device for the production and possibly also the storage of hydrogen by means of electric energy.

In order to allow easy inspection, the hydroelectric power plant according to the invention comprises a walkway both near the upstream intake works 1 and the pipeline 2, and in particular comprises a floating walkway near the downstream reach 2B of the pipeline 2.

Obviously, it is provided that the production island 5 is made in such a way as to allow the safe access and permanence of human operators for maintenance operations, as well as the housing of different devices such as for example:
a converter of mechanic energy into electric energy and vice versa, in case water is to be pumped up to store energy;
a device for controlling the mechanisms (oleodynamic or electric);
an electric protective device, in particular a lightning protective device;
a remote plant controlling and managing device;
a lighting and utility power device;
a device for regulating, controlling and measuring the energy produced;
a video surveillance device,
an energy conversion device,
an energy production device for auxiliary services, such as for example photovoltaic, mini-wind-power and/or electricity generating set,
a set of batteries for energy storage so as to ensure continuity of operation even in the absence of connection with the power grid outside the plant,
a device for the production of hydrogen by means of electric energy.

The production island 5 and, in particular, the floating platform 3 comprises a tail race (not visible in the figures), which causes the water exiting the hydraulic turbine 4 to flow out in the basin.

It is possible that the flow rate of water exiting the tail race creates horizontal thrusts on the floating platform 3, tending to make it move in one direction or another and thus creating excessive stresses on the elements of the anchoring device or excessive corrections of the positioning device.

To prevent this, the tail race has a partition so as to create at least two separate jets.

In the simplest case, the tail race is equipped with a bifurcation that causes the outflowing water to flow in two opposite ways in the same direction, so as to neutralise the horizontal thrusts.

It is of course possible to have three or more outlets of the tail race and a regulation device adapted to regulate the thrusts created by the water exiting the discharge duct, in order to counteract other horizontal thrusts due e.g. to the wind or the currents in the basin.

In the operation of the variable-head hydroelectric power plant, the water coming also from other valleys reaches the upstream intake works, is channelled in the pipeline 2, first travelling along the upstream reach 2A and then the flexible or movable downstream reach 2B, and then exits and is directed by one or more outflow nozzles on the impeller of the hydraulic turbine, thus rotating it.

Finally, the water is drained into the basin through the tail race.

The hydraulic turbine is arranged on a floating platform on the surface of the basin.

The flexible or movable downstream reach 2B of the pipeline 2 allows to modify the position of the floating platform, which, by floating on the surface of the basin, rises or lowers depending on the water level in the basin.

The flexible or movable downstream reach 2B of the pipeline 2 is equipped with floats 9 which allow it to float on the surface of the basin when the floating platform rises and which can act as supports for resting on the ground when the floating platform and the level of the basin are lowered.

Since the level of the free surface of the water in the basin can vary by several meters depending on evaporation, the use of water downstream and the flow rate from the upstream streams or other valleys, the arrangement of the hydraulic turbine on the floating platform 3 and its connection by a flexible or movable downstream reach 2B of the pipeline 2 allow to exploit in an optimal manner the head between the upstream intake works 1 and the water surface of the basin, regardless of the filling level of the same basin.

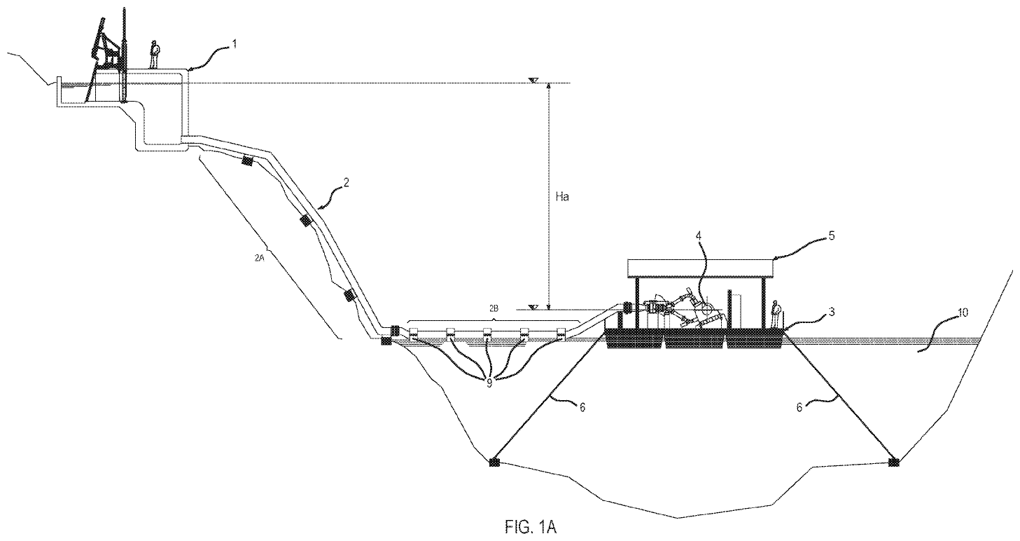

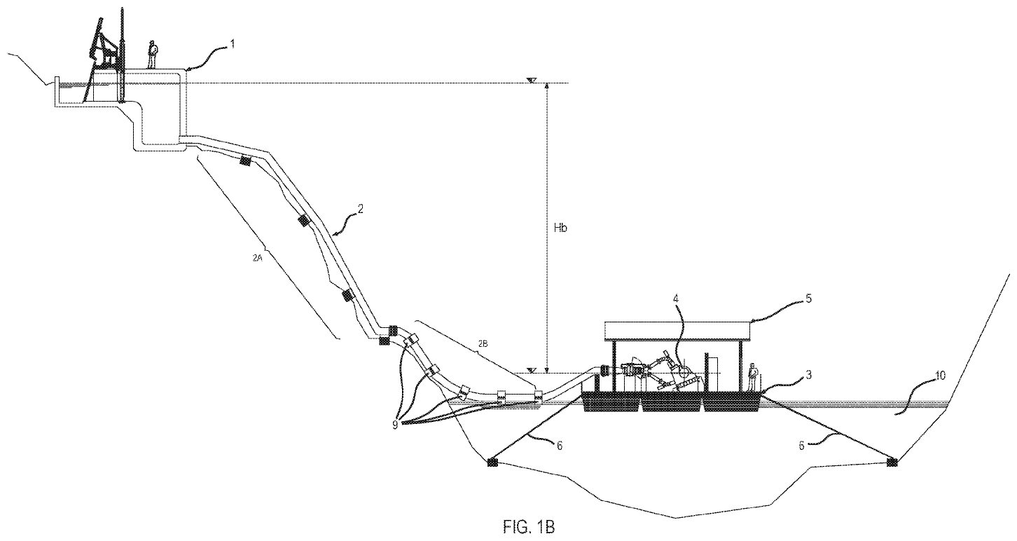

FIGS. 1A and 1B show how the floating platform and the flexible or movable downstream reach 2B of the pipeline 2 allow adaptation to several filling levels of the basin.

It is of course possible that the whole pipeline 2 is flexible, deformable or movable.

The positioning device or the passive anchoring device allows to prevent the floating platform from tending to move when pushed by the wind and currents and thus creating tensions on the downstream reach 2B of the pipeline 2, in particular, in the connection between the downstream reach 2B and the hydraulic turbine 4 and in the connection between the downstream reach 2B and the upstream reach 2A.

Because the hydraulic turbine is arranged on a platform that floats on the surface of the basin, the head between the upstream intake works and the surface of the basin can be exploited almost completely between a minimum value H_{A} corresponding to the maximum water level in the basin and a maximum value H_{B} corresponding to the minimum water level in the basin.

Obviously, the invention will be advantageously made with a length of the downstream reach 2B of the pipeline 2 such as to allow the operation of the plant both when the basin is at its maximum level and when the basin is at its minimum level.

It is of course possible to provide that the production island 5 allows the easy docking of a boat.

It is also useful to provide a land-based auxiliary facility containing equipment, spare parts, consumables, personal protective equipment, first aid elements, documentation and any other material that may be necessary or useful for the operation and maintenance of the plant. The auxiliary facility will be compliant with the current regulations regarding safety of use that will be deemed appropriate in any specific case, may be equipped with toilets and will be equipped with systems (light, utility power, air conditioning, heating, water, sewer, etc.) that should be necessary. The land-based auxiliary facility may further have a system of connection with the production island by means of a boat or, in general, of a vessel with characteristics suitably designed for the type of civil and industrial mixed use.

An advantageous feature of the invention is that it allows the generation of energy from renewable source, by exploiting an additional elevation head not currently exploited by hydroelectric power plants.

Another advantage of the invention is that it has a minimal environmental impact, since the construction of the machine room on a floating platform and the making of part of the pipeline in water avoid the need to make excavations, earth movement, construction of plinths, foundations and bases, making of reinforced concrete castings, except to a very limited extent, as well as access roads.

This aspect can also generate immediate savings in construction costs as it can avoid much of the civil works.

Moreover, there is a considerable reduction in the making times, since the construction of the more complex parts of the plant (electromechanical works) and the respective pre-operational tests (blank tests of the individual circuits) are totally or partially achievable during the workshop pre-manufacturing step, rather than solely at the construction site.

With appropriate organisation, the production island, comprising the floating platform, can be tested under real operating conditions during an end-of-production test by setting up a suitable test bench.

A further advantage is the ease and low economic cost of dismantling and the restoration of grounds at the end of the plant lifetime.

It is also possible to move a substantial part of the plant, since the production island can be made in such a way as to be easily moved both by navigating in the same basin and, after lifting, in another basin.

The production island can also be reused and positioned on the ground, after checking the feasibility at the specific site, in order to make a completely land-based hydraulic power plant.

The plant also allows to take advantage of the possibility of storing energy, in case of implementation of the solution with a production and pumping plant.

Another advantage is the possibility of hourly modulation of the energy production to serve the users at the appropriate time and not to unbalance the power grid with reactive power.

1. A variable head hydroelectric power plant comprising an upstream intake works adapted to intercept at least partially the water coming from a source, a pipeline connected to said upstream intake works in a manner adapted to receive and channel therein, at least partially, the water intercepted by the upstream intake works, comprising
a floating platform, adapted to be arranged and to float on the surface of a basin;
a hydraulic turbine arranged on the floating platform and connected to the pipeline, in a manner adapted to receive the water coming from the pipeline.

2. The hydroelectric power plant according to claim 1, wherein said pipeline comprises at least ono a flexible or movable downstream reach.

3. The hydroelectric power plant according to claim 2, wherein said downstream reach of the pipeline is floating.

4. The hydroelectric power plant according to claim 2, further comprising floats arranged on the downstream reach of the pipeline.

5. The hydroelectric power plant according to claim 1, further comprising a positioning device adapted to limit the displacement of the floating platform on the surface of the basin.

6. The hydroelectric power plant according to the preceding claim 5, wherein said positioning device comprises an anchoring device.

7. The hydroelectric power plant according to claim 6, wherein said anchoring device comprises flexible elements and the hydroelectric power plant comprises a tensioning device of said flexible elements to limit the displacements of the floating platform on the surface of the basin.

8. The hydroelectric power plant according to claim 1, further comprising an electromechanical device for converting mechanic energy into electric energy.

9. The hydroelectric power plant according to claim 2, further comprising a floating walkway adapted to allow the inspection of the downstream reach of the pipeline.

10. The hydroelectric power plant according to claim 1, wherein said floating platform comprises a tail race adapted to drain into the basin the water coming from the hydraulic turbine, creating at least two separate jets.
